(19) United States
(12) Patent Application Publication
(10) Pub. No.: US 2008/0076653 A1
(43) Pub. Date: Mar. 27, 2008

(54) Cushioning product, machine and method

(76) Inventors: Kenneth L. Shaw, Anaheim, CA (US); Gregory E. Vaught, Battle Ground, WA (US)

Correspondence Address: WOOD, HERRON & EVANS, LLP, 2700 CAREW TOWER, 441 VINE STREET, CINCINNATI, OH, 45202, US

(21) Appl. No.: 11/517,658

(22) Filed: Sep. 8, 2006

(51) Int. Cl. B31B 1/00

(52) U.S. Cl. 493/464

(57) ABSTRACT

A method of producing cushioning dunnage comprises the steps of providing a cushioning dunnage producing machine, providing a roll of paper sheet material, the roll of paper sheet material having a first end at a radially innermost location and a second end at a radially outermost location, feeding the first end of the paper sheet material into the cushioning dunnage producing machine, and producing cushioning dunnage with the cushioning dunnage producing machine. A cushioning product comprises an elongated sheet of paper having a longitudinal axis, the sheet of paper twisted about the longitudinal axis into a helix, the twisted sheet of paper crumpled along the longitudinal axis. A combination comprises a cushioning dunnage producing machine having a crumpler, a roll of paper sheet material having a first end at a radially innermost location and a second end at a radially outermost location, the first end fed into the cushioning dunnage producing machine, the crumpler drawing the paper sheet from the roll and crumpling the paper sheet into cushioning dunnage.

### FIELD OF THE INVENTION

This invention relates generally to cushioning products, and more specifically to a cushioning product of the type formed by crumpling (sometimes referred to as “converting”) paper sheet material.

### BACKGROUND OF THE INVENTION

In the process of shipping an item from one location to another, a protective packaging material is typically placed in the shipping carton or box, to fill any voids and/or to cushion the item during the shipping process. Examples of protective packaging materials are foam “peanuts,” air filled plastic “pillows,” and paper sheet material “converted” into cushioning pads.

A number of machines have been proposed for crumpling or “converting” paper sheet into cushioning pads or “dunnage.” One particularly commercially successful machine is disclosed in U.S. Pat. No. 6,106,452 for Machines And Methods For Making Cushioning Dunnage Products By Crumpling Paper, hereby incorporated by reference herein in its entirety. In dunnage producing machines in general, a roll of paper sheet is rotatably supported on the frame of the machine. The leading end of the paper sheet is fed into the machine, the machine draws the paper sheet into it by rotating the roll of paper (i.e. unrolling the roll), and the machine crumples the paper into dunnage.

The amount of paper which can be utilized is limited due to size and weight considerations. First, since the machine itself carries the roll of paper, the machine must be able to physically accommodate the size of the roll. While it would be desirable to have the machine be able to handle larger rolls of paper to reduce downtime of the machine due to the machine having to be refilled by an operator, a larger roll requires a larger machine to handle the larger physical size of the roll and/or a heavier machine (or a machine with a redesigned base) to avoid tipping of the machine, etc. Second, the rotational moment of inertia of a larger roll of paper creates problems for the machine in drawing the paper off the roll. Once the roll reaches a certain weight (and hence a certain rotational moment of inertia), the force required to draw (unroll) the paper from the roll exceeds the tensile strength of the paper, thus causing the paper to tear.

Dunnage producing machines such as the one shown in U.S. Pat. No. 6,106,452 and discussed above, and shown in U.S. Pat. No. 3,603,216, include a forming/folding/rolling apparatus to form/fold/roll the paper sheet prior to crumpling, to add thickness/resilience to the finished dunnage product. Such forming/folding/rolling apparatus adds cost and complexity to the dunnage machine.

It is desirable to be able to utilize larger rolls of paper for dunnage machines without suffering from the aforementioned disadvantages of larger rolls.

It is also desirable to be able to eliminate forming/folding apparatus from the dunnage machine.

### SUMMARY OF THE INVENTION

In one aspect, the invention is a method of producing cushioning dunnage. The method comprises the steps of providing a cushioning dunnage producing machine, providing a roll of paper sheet material, the roll of paper sheet material having a first end at a radially innermost location and a second end at a radially outermost location, feeding the first end of the paper sheet material into the cushioning dunnage producing machine, and producing cushioning dunnage with the cushioning dunnage producing machine.

The step of feeding the first end of the paper sheet material into the cushioning dunnage producing machine can further comprise feeding the first end of the paper sheet from the roll with the roll standing on end. The step of feeding the first end of the paper sheet material into the cushioning dunnage producing machine can further comprise twisting the sheet about a longitudinal axis of the sheet into a helix. The step of providing a cushioning dunnage producing machine can further comprise providing a cushioning dunnage producing machine having a pair of opposed rollers, at least one of which is driven, which draw the paper sheet from the roll and which crumple the paper sheet.

In another aspect, the invention is a cushioning product comprising an elongated sheet of paper having a longitudinal axis, the sheet of paper twisted about the longitudinal axis into a helix, the twisted sheet of paper crumpled along the longitudinal axis.

In yet another aspect, the invention is a combination comprising a cushioning dunnage producing machine having a crumpler, a roll of paper sheet material having a first end at a radially innermost location and a second end at a radially outermost location, the first end fed into the cushioning dunnage producing machine, the crumpler drawing the paper sheet from the roll and crumpling the paper sheet into cushioning dunnage.

The roll can be positioned standing on end. The sheet can twist about a longitudinal axis of the sheet into a helix as the sheet is drawn from the roll and into the machine. The machine can comprise a base and a support extending upwardly from the base, the crumpler mounted on the support. The crumpler can comprise a pair of opposed rollers, at least one of which is driven. The pair of opposed rollers can comprise a driven roller and an idler roller. The driven roller and idler roller can be mounted for relative movement therebetween such that a distance between the driven roller and idler roller can be adjusted to vary an amount of compression imparted to the paper sheet. The machine can further comprise a motor for driving the driven roller. The machine can further comprise a pair of guide rollers mounted to at least one of the support and the crumpler to aid in transitioning the sheet from the roll to the crumpler. The machine can further comprise a roll supporting platform mounted to the support for supporting the roll of paper sheet material.

The invention thus permits larger rolls of paper to be utilized for dunnage machines without the size and weight of the roll necessitating changes in the design of the machine or causing the paper to tear during feeding into the machine.

The invention also eliminates the requirement of forming/folding/rolling apparatus in a dunnage machine.

These and other features and advantages of the present invention will become more readily apparent during the following detailed description taken in conjunction with the drawings herein, in which:

### BRIEF DESCRIPTION OF THE DRAWINGS OF THE INVENTION

FIG. 1 is a perspective view of a cushioning dunnage producing machine and a roll of paper sheet material according to the invention,

FIG. 2 is a side view of the machine and material of FIG. 1, and

FIG. 3 is a perspective view of the roll of paper sheet material as it is unrolled from a first end at a radially innermost location of the roll and as it is twisted about its longitudinal axis into a helix as it is drawn off of the roll and into the machine of FIGS. 1 and 2.

### DETAILED DESCRIPTION OF THE INVENTION

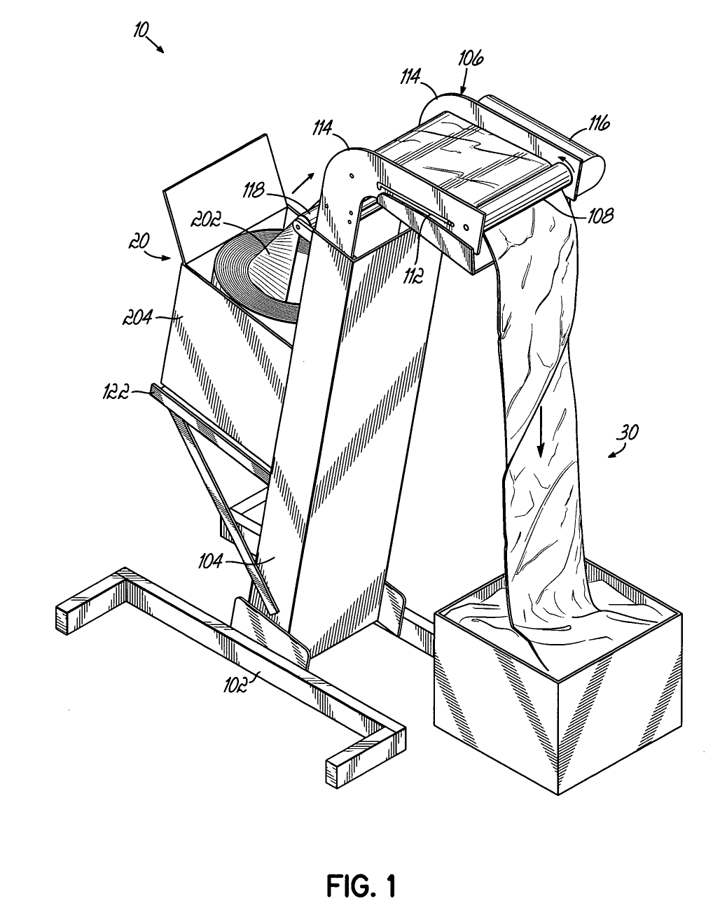

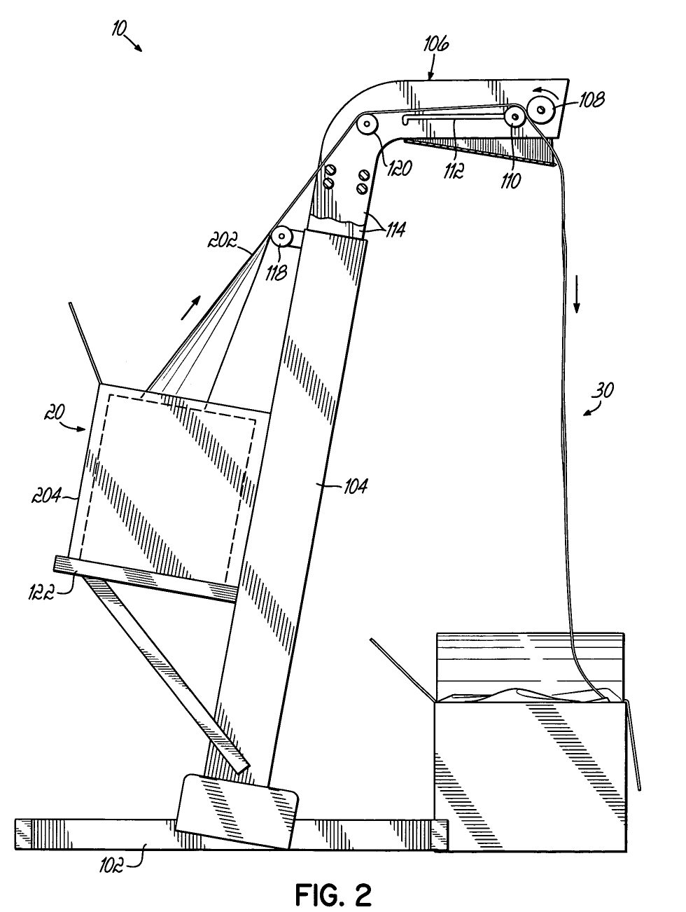

Referring first to FIGS. 1 and 2, a cushioning dunnage producing machine 10, a roll 20 of paper sheet material for feeding the machine 10, and the resulting cushioning dunnage 30 produced by the machine 10, are illustrated.

Machine 10 can include a base 102, a support 104 extending upwardly from the base 102, and a crumpler 106 mounted on the support 104. Crumpler 106 can be in the form of a driven roller 108 which can cooperate with an idler roller 110 to crumple the paper sheet 202 being unrolled from the roll 20, as will be described in more detail below. Idler roller 110 can be mounted in parallel tracks 112, 112 in sides 114, 114 of crumpler 106 to provide a means of adjusting the distance between the crumpling roller 108 and the idler roller 110 and hence the amount of compression, or crumple, imparted to the sheet 202. Driven roller 108 can be driven by a motor, for example electric motor 116, which can be mounted to a side 114 of the crumpler 106. An additional pair of guide rollers 118 and 120 can be mounted to the support 104 and/or crumpler 106 to aid in transitioning the sheet 202 from the roll 20 to the crumpler 106. A roll supporting platform 122 can be mounted to the support 104 for supporting the roll 20 of paper sheet material. In the alternative, the roll 20 can simply be placed on a supporting surface, such as a table top, floor, etc., and at any orientation to include upright (vertical), horizontal, and any inclination therebetween. Roll 20 can be placed in a box 204 supported on platform 122. Other types of dunnage producing machines can be employed in the practice of the invention other than the machine 10 illustrated. For example, dunnage producing machines of the types shown in U.S. Pat. Nos. 6,106,452 and 3,603,216 can be employed in the practice of the invention.

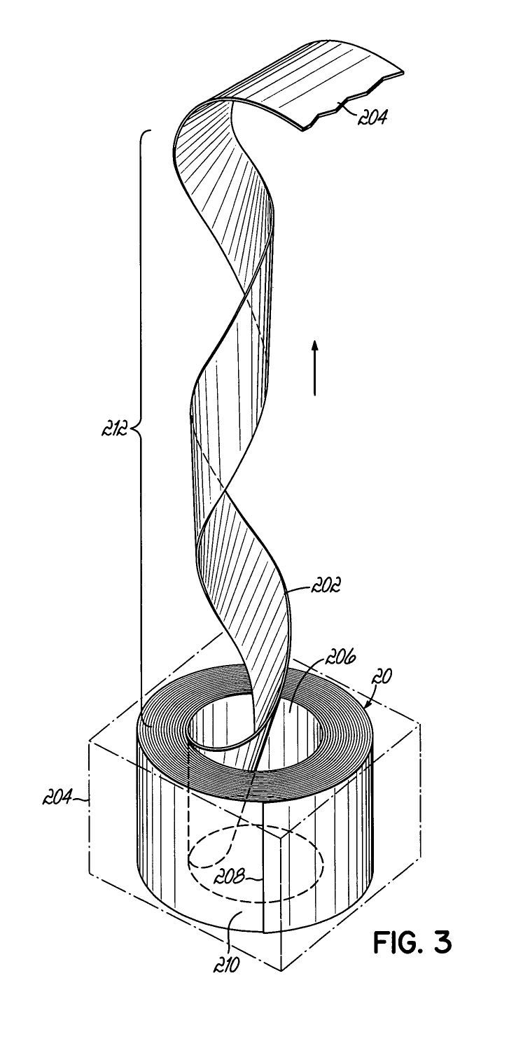

Referring now to FIG. 3, the roll 20 of paper sheet 202 is illustrated as it is unrolled from, i.e. drawn off of, the roll 20 and into the machine 10 of FIGS. 1 and 2. The roll 20 of paper sheet 202 has a first end 204 which is originally located at a radially innermost location 206, and a second end 208 located at a radially outermost location 210. (Since, as purchased, a typical roll 20 of paper sheet 202 comes wound on a stiff inner cardboard tube, the tube is first removed from the interior of the roll 20 of paper 202.) As the first end 204 of the paper sheet 202 is fed into the cushioning dunnage producing machine 10, the sheet 202 twists about a longitudinal axis of the sheet 202 into a helix 212. The helix 212 of paper sheet 202 is then crumpled with the rollers 108, 110.

The invention thus permits larger rolls of paper to be utilized for dunnage machines without the size and weight of the roll necessitating changes in the design of the machine and/or causing the paper to tear during feeding into the machine. And, forming/folding/rolling apparatus to form/fold/roll the paper sheet prior to crumpling, such as that shown in U.S. Pat. Nos. 6,106,452 and 3,603,216, is not required since unrolling the roll “from the inside out” generates a paper sheet helix, i.e. forms/folds/rolls the paper sheet without any such forming/folding/rolling apparatus per se.

Those skilled in the art will readily recognize numerous adaptations and modifications which can be made to the present invention which will result in an improved cushioning product and method, yet all of which will fall within the spirit and scope of the present invention as defined in the following claims. Accordingly, the invention is to be limited only by the scope of the following claims and their equivalents.

What is claimed is:

1. A method of producing cushioning dunnage comprising the steps of:
providing a cushioning dunnage producing machine,
providing a roll of paper sheet material, the roll of paper sheet material having a first end at a radially innermost location and a second end at a radially outermost location,
feeding the first end of the paper sheet material into the cushioning dunnage producing machine, and
producing cushioning dunnage with the cushioning dunnage producing machine.

2. The method of claim 1 wherein the step of feeding the first end of the paper sheet material into the cushioning dunnage producing machine further comprises feeding the first end of the paper sheet from the roll with the roll standing on end.

3. The method of claim 1 wherein the step of feeding the first end of the paper sheet material into the cushioning dunnage producing machine further comprises twisting the sheet about a longitudinal axis of the sheet into a helix.

4. The method of claim 1 wherein the step of providing a cushioning dunnage producing machine further comprises providing a cushioning dunnage producing machine having a pair of opposed rollers, at least one of which is driven, which draw the paper sheet from the roll and which crumple the paper sheet.

5. A cushioning product comprising:
an elongated sheet of paper having a longitudinal axis, said sheet of paper twisted about the longitudinal axis into a helix, said twisted sheet of paper crumpled along the longitudinal axis.

6. A combination comprising:
a cushioning dunnage producing machine having a crumpler,
a roll of paper sheet material having a first end at a radially innermost location and a second end at a radially outermost location, said first end fed into said cushioning dunnage producing machine,
said crumpler drawing said paper sheet from said roll and crumpling said paper sheet into cushioning dunnage.

7. The combination of claim 6 wherein said roll is positioned standing on end.

8. The combination of claim 6 wherein said sheet twists about a longitudinal axis of said sheet into a helix as said sheet is drawn from said roll and into said machine.

9. The combination of claim 6 wherein said machine comprises a base and a support extending upwardly from said base, said crumpler mounted on said support.

10. The combination of claim 9 wherein said crumpler comprises a pair of opposed rollers, at least one of which is driven.

11. The combination of claim 10 wherein said pair of opposed rollers comprises a driven roller and an idler roller.

12. The combination of claim 11 wherein said driven roller and idler roller are mounted for relative movement therebetween such that a distance between said driven roller and idler roller can be adjusted to vary an amount of compression imparted to said paper sheet.

13. The combination of claim 11 wherein said machine further comprises a motor for driving said driven roller.

14. The combination of claim 9 wherein said machine further comprises a pair of guide rollers mounted to at least one of said support and said crumpler to aid in transitioning said sheet from said roll to said crumpler.

15. The combination of claim 9 wherein said machine further comprises a roll supporting platform mounted to said support for supporting said roll of paper sheet material.
